(19) United States
(12) Patent Application Publication
(10) Pub. No.: US 2025/0086514 A1
(43) Pub. Date: Mar. 13, 2025

(54) Method for Handling Distractive Samples During Interactive Machine Learning

(71) Applicant: ABB Schweiz AG, Baden (CH)

(72) Inventors: Benjamin Kloepper, Mannheim (DE); Dawid Ziobro, Västerås (SE); Divyasheel Sharma, Bangalore (IN); Benedikt Schmidt, Heidelberg (DE); Yemao Man, Solna (SE); Gayathri Gopalakrishnan, Eskilstuna (SE); Joakim Astrom, Solna (SE); Marcel Dix, Allensbach (DE); Arzam Muzaffar Kotriwala, Ladenburg (DE)

(73) Assignee: ABB Schweiz AG, Baden (CH)

(21) Appl. No.: 18/929,807

(22) Filed: Oct. 29, 2024

Related U.S. Application Data
(63) Continuation of application No. PCT/EP2022/061582, filed on Apr. 29, 2022.

(51) Int. Cl. G06N 20/00

(52) U.S. Cl. CPC G06N 20/00

(57) ABSTRACT

A method for deciding on a machine learning model result quality based on the identification of distractive samples in the training data includes providing a first result of the model based on initial training data; determining a first performance of the first result of the model; logging input data; providing a second result of the model based on initial training data and the input data, determining a second performance of the second result of the model and thereon based identifying erroneous data within the input data and/or the training data.

### CROSS-REFERENCE TO RELATED APPLICATIONS

The instant application claims priority to International Patent Application No. PCT/EP2022/061582, filed Apr. 29, 2022, which is incorporated herein in its entirety by reference.

### FIELD OF THE DISCLOSURE

The present disclosure relates to a method for handling distractive samples during interactive machine learning.

### BACKGROUND OF THE INVENTION

The general background of this disclosure is interactive machine learning, ML, in the form of for instance active learning, explanatory learning, or visual interactive labeling are a good way to acquire labels for supervised machine learning models. But humans including experts are not free of error and thus might provide incorrect or misleading input during the interactive machine learning process.

Keeping track of the inputs provided by the human, identifying and removing inputs that are incorrect and or lead to an inferior performance of the machine learning is largely unsupported in interactive machine learning systems. This makes the debugging of models a very tedious task.

### BRIEF SUMMARY OF THE INVENTION

In one aspect, the present disclosure describes a method for deciding on a machine learning model result quality based on the identification of distractive samples in the training data is presented, the method comprising: providing a first result of the model based on initial training data; determining a first performance of the first result of the model; logging input data; providing a second result of the model based on initial training data and the input data, determining a second performance of the second result of the model and thereon based identifying erroneous data within the input data and/or the training data.

The solution extends the interactive machine learning workflows with a concurrent process of logging inputs, checking the inputs regarding to their impact on model performance and identifying samples that are likely containing incorrect labels or otherwise erroneous data.

Embodiments in accordance with the disclosure extend the interactive machine learning, ML, workflows with a concurrent process of logging inputs, checking the inputs regarding to their impact on model performance and identifying samples that are likely containing incorrect labels or otherwise erroneous data.

The key step is the identification of distractive samples in the training data. Distractive samples are samples that cause the model to perform worse if added or kept in the training data. There are various strategies to identify distractive samples: Measure the model performance with and without the sample in the training, a validation, or a test data set; tracking the model performance on the training, a validation, or a test data set, identifying samples that cause a uncommon large change in the model parameters, searching for samples that are different from samples with the same class label, but similar to samples with a different class label, interactively explore data using a dimensionality reduction technique.

### BRIEF DESCRIPTION OF THE SEVERAL VIEWS OF THE DRAWING(S)

FIG. 1 is a flow diagram of a method for Active Learning with Human Experts in accordance with the disclosure.

FIG. 2 is a diagram of an embodiment of a Workflow of Explanatory Machine Learning in accordance with the disclosure.

FIG. 3 illustrates a concurrent Workflow of cleaning distractive samples in accordance with the disclosure.

### DETAILED DESCRIPTION OF THE INVENTION

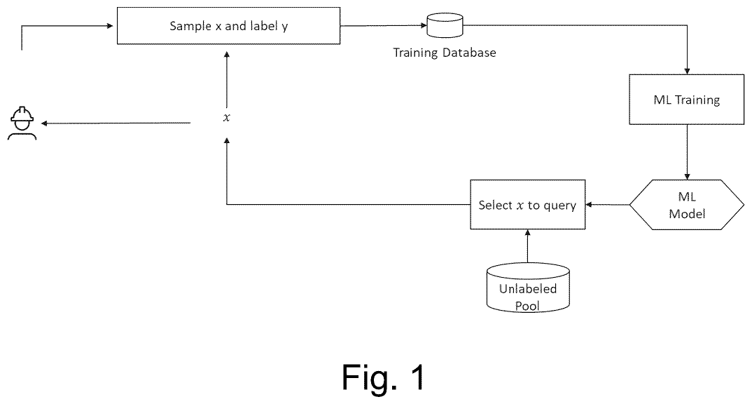

FIG. 1 illustrates a flow diagram of a method for Active Learning with Human Experts. The scope of the disclosure is interactive machine learning. FIG. 1 shows for example the workflow of active learning with a human experts providing labels. A machine learning model is trained on a small initial training data set and the model is used by a query function to identify a sample from a large pool of un-sampled data to that the human expert should provide a label for. Once the expert provides the label, the model is trained again and the process repeats. In variants of the process, more than one sample might be selected from the pool.

Another example of an interactive machine workflow is explanatory learning. The explanatory workflow. The starting point of this process is a machine learning model trained on a (small) set of labeled training data. An initial training model is created and is used to select samples from a (large) pool of unlabeled samples for query to a user. The prediction y* of the machine learning model for the sample x is produced and explanation function creates an explanation z* of the model output y*. Sample x, output y* and explanation z* are provided to a human user. The human user can provide a correction C and the correction C is used to generate artificial data with counter examples w.r.t. to the explanation z* and the model output y*.

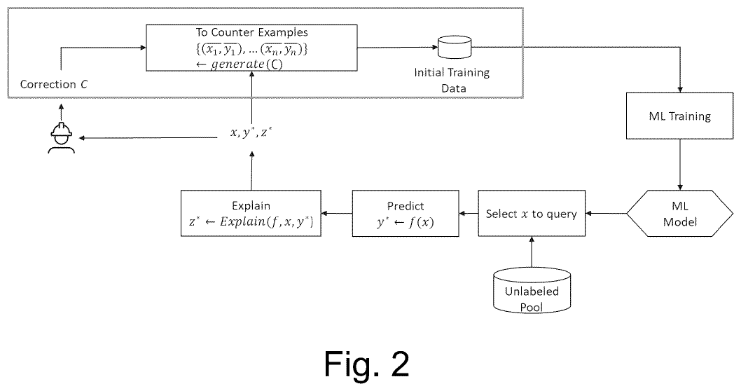

FIG. 2 illustrates an example embodiment of a Workflow of Explanatory Machine Learning.

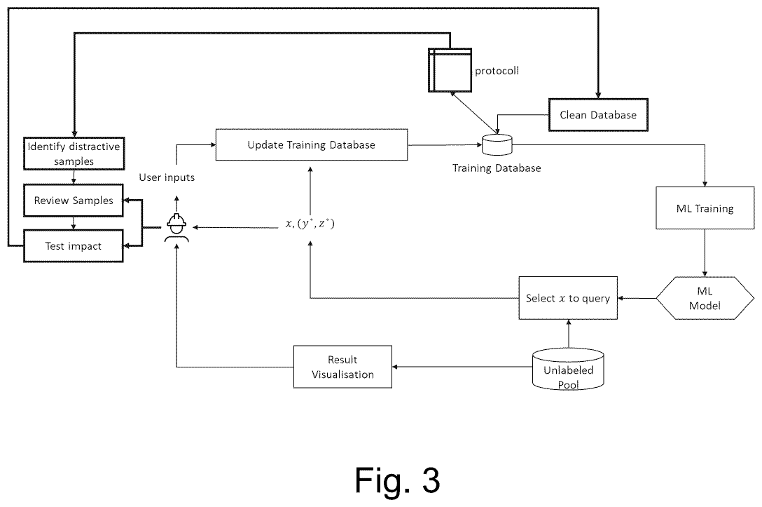

FIG. 3 illustrates a concurrent Workflow of cleaning distractive samples. FIG. 3 shows a generic interactive ML workflow and in bold the extensions for dealing with distractive samples.

First, the basic workflow is extended by a protocol. The protocol documents which data samples have been added in which iteration to the training data base. The protocol is used in the identification of distractive samples.

The identification of distractive samples analyses the samples in order to suggest candidates that are possible distractive samples. There are several methods that can be used individually or in combination to identify distractive samples.

A first method analyzes the impact of the samples on the performance of the model. The performance of the model might be measures on the training data set, a separate validation or test data set or using cross-validation on the training data set. The first way of analyzing the impact is tracking the performance of the model in each iteration and identifying if the model does not improve as usually or even degrades. The samples added in this iteration are potentially distractive samples.

The model might be also trained leaving out individual samples and comparing the model performance in case the sample was included or not. If removing the sample improve the performance, the sample is a possible distractive sample.

A second method is to analyze the parameters of the machine learning and compare how much the model parameter change if a sample is included in the training data set or not. Samples that cause a large change are very influential and should be checked if they are distractive.

A third method is to analyze samples where the labels differ from similar samples. In case of classification, such samples have a class label A but are less similar to other samples with label “A” then to samples with another label B. The similarity is measured based on the feature of samples and a suitable similarity or distance measure like Euclidian distance, cosine similarity, dynamic time warping, or Jaccard index.

The present disclosure has been described in conjunction with a preferred embodiment as examples as well. However, other variations can be understood and effected by those persons skilled in the art and practicing the claimed invention, from the studies of the drawings, this disclosure and the claims.

Notably, in particular, the any steps presented can be performed in any order, i.e. the present invention is not limited to a specific order of these steps. Moreover, it is also not required that the different steps are performed at a certain place or at one node of a distributed system, i.e. each of the steps may be performed at a different nodes using different equipment/data processing units.

The identified potential distractive samples are made accessible to the human user for review. The human user needs to review whether the samples have the correct labels and the provided input is correct as well. For active learning and VIAL the required input only concern the labels. The user can decide to correct the label, to remove a sample entirely from training data, or to leave label uncorrected. In case of an explanatory workflow, the user can provide and updated correction and trigger the generation of new artificial data.

Artificial data might be also generated if in an active learning workflow an identified sample is correctly labeled. Artificial data similar to this sample should enforce the patterns present in the sample wrongly identified as distractive and hence help the model to capture the correct concepts and patterns.

In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

In an embodiment of the method for deciding on a machine learning model result quality based on the identification of distractive samples in the training data, the identifying erroneous data comprises an identification of distractive samples in the input data and/or the training data.

In an embodiment of the method for deciding on a machine learning model result quality based on the identification of distractive samples in the training data, distractive samples are samples that cause the model to perform worse if added or kept in the training data.

In an embodiment of the method for deciding on a machine learning model result quality based on the identification of distractive samples in the training data, the identifying erroneous data comprises measure the model performance with and without the sample on the training.

In an embodiment of the method for deciding on a machine learning model result quality based on the identification of distractive samples in the training data, the identifying erroneous data comprises tracking the model performance on the training.

In an embodiment of the method for deciding on a machine learning model result quality based on the identification of distractive samples in the training data, the identifying erroneous data comprises identifying samples that cause a uncommon large change in the model parameters.

In an embodiment of the method for deciding on a machine learning model result quality based on the identification of distractive samples in the training data, the identifying erroneous data comprises searching for samples that are different from samples with the same class label.

In an embodiment of the method for deciding on a machine learning model result quality based on the identification of distractive samples in the training data, identifying erroneous data comprises analyzing the model performance to identify distractive samples.

In an embodiment of the method for deciding on a machine learning model result quality based on the identification of distractive samples in the training data, the identifying erroneous data comprises analyzing the impact on model features to identify distractive samples.

In an embodiment of the method for deciding on a machine learning model result quality based on the identification of distractive samples in the training data, the identifying erroneous data comprises analyzing the similarity across different classes to identify distractive samples.

In an embodiment of the method for deciding on a machine learning model result quality based on the identification of distractive samples in the training data, the identifying erroneous data comprises applying dimensionality reduction techniques and visualization in 2D or 3D for interactive identification of distractive samples.

In an embodiment of the method for deciding on a machine learning model result quality based on the identification of distractive samples in the training data, the method is performed using a user interface and dashboard for reviewing possible distractive samples.

In one aspect of the disclosure, a system for deciding on a machine learning model result quality based on the identification of distractive samples in the training data is provided, the system comprising a processor for executing the method according to the first aspect.

As used herein “determining” also includes “initiating or causing to determine,” “generating” also includes “initiating or causing to generate” and “providing” also includes “initiating or causing to determine, generate, select, send or receive”. “Initiating or causing to perform an action” includes any processing signal that triggers a computing device to perform the respective action.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for deciding on a machine learning model result quality based on the identification of distractive samples in the training data, comprising:
providing a first result of the model based on initial training data;
determining a first performance of the first result of the model;
logging input data;
providing a second result of the model based on initial training data and the input data; and
determining a second performance of the second result of the model and thereon based identifying erroneous data within the input data and/or the training data.

2. The method according to claim 1, wherein the identifying erroneous data comprises an identification of distractive samples in the input data and/or the training data.

3. The method according to claim 2, when the distractive samples are samples that cause the model to perform worse if added or kept in the training data.

4. The method according to claim 1, wherein the identifying erroneous data comprises measure the model performance with and without the sample on the training.

5. The method according to claim 1, wherein the identifying erroneous data comprises tracking the model performance on the training.

6. The method according to claim 1, wherein the identifying erroneous data comprises identifying samples that cause a uncommon large change in the model parameters.

7. The method according to claim 1, wherein the identifying erroneous data comprises searching for samples that are different from samples with the same class label.

8. The method according to claim 1, wherein the identifying erroneous data comprises analyzing the model performance to identify distractive samples.

9. The method according to claim 1, wherein the identifying erroneous data comprises analyzing the impact on model features to identify distractive samples.

10. The method according to claim 1, wherein the identifying erroneous data comprises analyzing the similarity across different classes to identify distractive samples.

11. The method according to claim 1, wherein the identifying erroneous data comprises applying dimensionality reduction techniques and visualization in 2D or 3D for interactive identification of distractive samples.

12. The method according to claim 1, wherein the method is performed using a user interface and dashboard for reviewing possible distractive samples.
